(19) United States
(12) Patent Application Publication
(10) Pub. No.: US 2022/0400788 A1
(43) Pub. Date: Dec. 22, 2022

(54) LOOP FREE FACE MASK

(71) Applicant: Demetria Michelle Brown, Matteson, IL (US)

(72) Inventor: Demetria Michelle Brown, Matteson, IL (US)

(21) Appl. No.: 17/735,170

(22) Filed: May 3, 2022

Related U.S. Application Data
(60) Provisional application No. 63/258,417, filed on May 4, 2021.

(51) Int. Cl. A41D 13/11

(52) U.S. Cl. CPC A41D 13/1169

(57) ABSTRACT

An article of manufacture that allows mask-wearers to wear an air filtration mask or a high air filtration mark without dealing with the discomfort and inconvenience of using attached loops. A loop-free mask is adapted to be reusable and releasably engage, via medical-grade adhesive strips, to the buccal and infraorbital regions on both sides of the face.

### CROSS REFERENCE TO RELATED APPLICATIONS

This application claims the benefit of priority to U.S. Provisional App. No. 63/258,417 filed, May 4, 2021, the contents therein are incorporated by reference in its entirety therein.

### FIELD

The present disclosure relates to hygienic supplies and personal protective equipment for the face, and more particularly, relates to face masks used to reduce the transmission of droplet-spread diseases.

### BACKGROUND

The current global challenge of COVID-19 pandemic has surpassed the provincial, radical, conceptual, spiritual, social, and pedagogical boundaries. According to the Center of Disease Control, COVID-19 is primarily transmitted from person-to-person through respiratory droplets. These droplets are released when someone with COVID-19 sneezes, coughs, or talks. Infectious droplets can land in the mouths or noses of people who are nearby or possibly be inhaled into the lungs. A physical distance of at least 1 meter (3 ft) between persons is suggested by the World Health Organization (WHO) to avoid infection, although some WHO member states have recommended maintaining greater distances whenever possible. Respiratory droplets can land on hands, objects or surfaces around the person when they cough or talk, and people can then become infected with COVID-19 from touching hands, objects or surfaces with droplets and then touching their eyes, nose, or mouth. Recent data suggest that there can be transmission of COVID-19 through droplets of those with mild symptoms or those who do not feel ill. Short-range inhalation of aerosols is a possibility for COVID-19, as with many respiratory pathogens. However, this cannot easily be distinguished from “droplet” transmission based on epidemiologic patterns. Short-range transmission is a possibility particularly in crowded medical wards and inadequately ventilated spaces. Certain procedures in health facilities can generate fine aerosols and should be avoided whenever possible.

COVID-19 has a mean incubation period of 5.2 days. The infection is acute without any carrier status. Symptoms usually begin with nonspecific syndromes, including fever, dry cough, and fatigue. Multiple systems may be involved, including respiratory (cough, short of breath, sore throat, rhinorrhea, hemoptysis, and chest pain), gastrointestinal (diarrhea, nausea, and vomiting), musculoskeletal (muscle ache), and neurologic (headache or confusion). More common signs and symptoms are fever, cough and short of breath. There were about 15% with fever, cough, and short of breath.

Surgical and ventilation masks come in a variety of shapes and sizes. They are largely bought and worn to prevent exposure to particulate-spread pathogens. During global pandemics, they are household items in order to prevent the spread or contraction of disease. The masks, however, use ear-loops or behind-the-head straps to secure it in place. These looped straps can cause physical discomfort, disrupt glasses' placement, and break off during use.

### SUMMARY

In light of the foregoing background, the following presents a simplified summary of the present disclosure to provide a basic understanding of some aspects of the disclosure. This summary is not an extensive overview of the disclosure. It is not intended to identify key or critical elements of the disclosure, or to delineate the scope of the disclosure. The following summary merely presents some concepts of the disclosure in a simplified form as a prelude to the more detailed description provided below.

The present disclosure pertains to an article of manufacture that allows mask-wearers to wear an air filtration mask or a high air filtration mark without dealing with the discomfort and inconvenience of using attached loops. An aspect of the disclosure includes a loop-free mask adapted to be reusable and releasably engage, via medical-grade adhesive strips, to the buccal and infraorbital regions on both sides of the face. The face mask of the present disclosure provides a loop free, less painful way of adhering a face mask to reduce the transmission of COVID-19.

An aspect of the disclosure includes a loop-free face mask body including a superior edge; an inferior edge; a right lateral edge; a left lateral edge; an adhesive strip on the right lateral edge of a posterior display of the face mask body; and an adhesive strip on the left lateral edge of the posterior display of the face mask body.

An aspect of the disclosure includes a loop-free mask adapted to be reusable and releasably engage face of a wearer. The face mask may have a superior edge; an inferior edge; a right lateral edge; a left lateral edge; a right bucca-infraorbital adhesive strip being juxtaposed to the right lateral edge of a posterior display of the face mask body; and a left bucca-infraorbital adhesive strip being juxtaposed to the left lateral edge of the posterior display of the face mask body.

An aspect of the disclosure includes a loop-free face mask body including a skin friendly releasable adhesive strips on each edge of the mask body adapted to fit on the nasal region, infraorbital region, oral region, zygomatic region, buccal region, and mental region of a face of a wearer.

In one aspect of the disclosure, using a contoured mask, double-sided, medical-grade silicone adhesive strips are vertically may be placed approximately 0.5 to 0.25 inches away from the inner right and left side edges of the mask. In one aspect of the disclosure, the mask may be reused several times, due to skin releasable adhesive strips. In another aspect, thin width adhesive strips may be curved along the contoured right and left side edges of the mask body, although straight adhesive strips may be used.

In one aspect of the disclosure, a loop-free face mask body may be composed of a KN95 or N95 air filtration material. The face mask body may also feature a flexible nose bridge section to reduce fog production for glasses-wearers and allow for a better fit along contours of the wearer's face.

### BRIEF DESCRIPTION OF THE FIGURES

The foregoing summary as well as the following detailed description, considered in conjunction with the accompanying drawings, provide a better understanding of the disclosure, in which like reference numbers refer to like elements, and wherein:

FIG. 1 shows a schematic view of the posterior display of a face mask body according to certain aspects of the present disclosure.

FIG. 2 shows a schematic view left anterior view of the face mask body folded along the angled seam according to certain aspects of the present disclosure.

FIG. 3 shows a schematic depiction of the anterosuperior view of the midline and right lateral facial regions of a human body used with certain aspects of the present disclosure.

FIG. 4 shows a schematic depiction of the anterosuperior view of the right lateral facial regions with the face mask body superimposed over the face, in which the right mask body edge is adapted to sit over the infraorbital and buccals regions of the right side of the face of a human body, and the angled seam sits long the midline of the face according to certain aspects of the present disclosure.

### DETAILED DESCRIPTION

In the following description of various aspects, a reference is made to the accompanying drawings to demonstrate various ways the disclosure may be used. It is understood that modifications or alternative methods may be used, but those modifications and alternatives do not detract from the present disclosure.

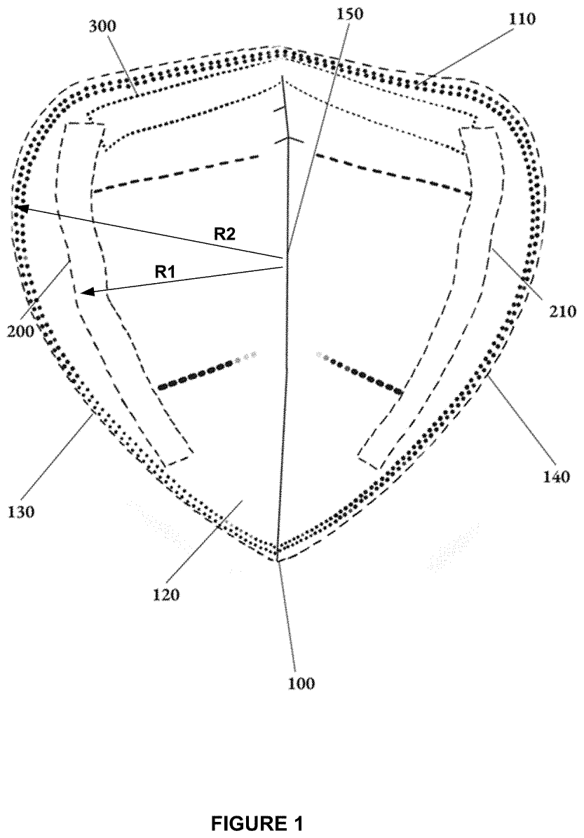

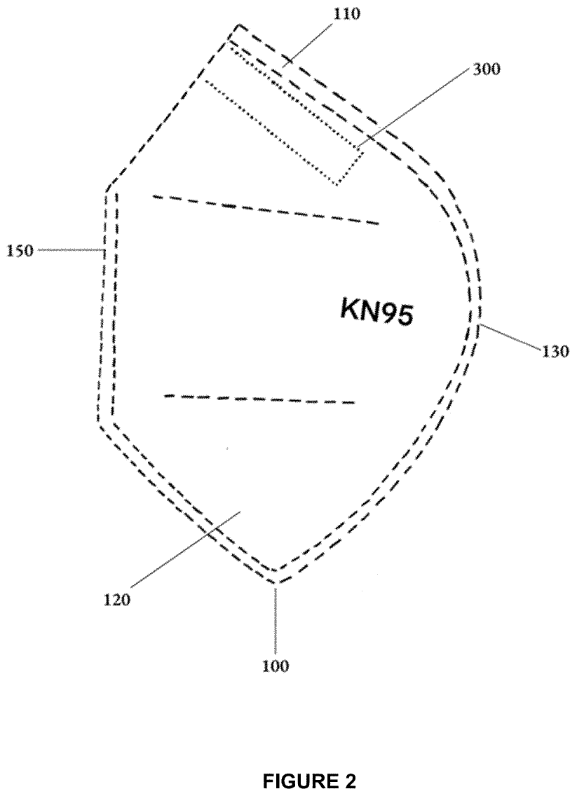

Referring to the accompanying FIGS. 1-4, a face mask body 100 in accordance with the present disclosure is discussed. FIG. 1 shows schematic view of the posterior display of the face mask, which includes a left adhesive strip 200 and a right adhesive strip 210 on the left mask edge 130 and right mask edge 140, respectively, of the face mask body 100, a flexible nose bridge 300 is disposed towards the superior mask body edge 110, and the posterior view of the angled seam 150 along the midline of KN95 face mask.

The figures illustrate the body and shape of the face mask 100, the size and placement of silicone-adhesive strips 200, 210, and the flexible nose bridge 300 along the superior edge 110 of the face mask body 100. In describing the placement of the face mask on the face of a human body, reference may be made to the musculoskeletal anatomical facial regions and/or facial muscles of a human body. Such references are not intended to demarcate precise areas; rather, they are intended to delineate general areas to aid in the following discussion. Nevertheless, specific regional interactions of structural face mask features may be used to describe the mask within the spirit of the disclosure.

FIG. 1 shows a face mask with an inwardly curved adhesive strip affixed to the posterior display of the face mask body 100 on each being in juxtaposition to the curved right 140 and left 130 lateral edges. The right lateral edge 140 of the face mask body 100 is equipped with an adhesive strip (henceforth, the right lateral adhesive strip 210) running vertically from the superior edge 110 of the face mask body 100 to the inferior edge 120 of the face mask body 100, approximately 0.25 inches inwardly proximal to the right lateral edge 140 of the face mask body 100. The left lateral edge 130 of the face mask body 100 is equipped with an adhesive strip (henceforth, the left lateral adhesive strip 200) designed in a mirrored fashion to the right lateral edge 140 of the face mask body 100. The figures show the left and right adhesive strips 200 and 210 respectively, measuring approximately 3.0 inches in length for an adult mask; other constructions may feature differing adhesive strip lengths in proportion with the size of the face mask body. The adhesive strips measure approximately 0.5 inches in lateral width.

The adhesive strips may comprise a polymeric film coated on both sides with a releasable skin friendly medical-grade silicone polymer adhesive. One side of the film is then placed onto the KN95 masks in the aforementioned placement, and a peelable protective plastic film covers the other side so that the adhesive is protected until the wearer 300 is ready to use the face mask.

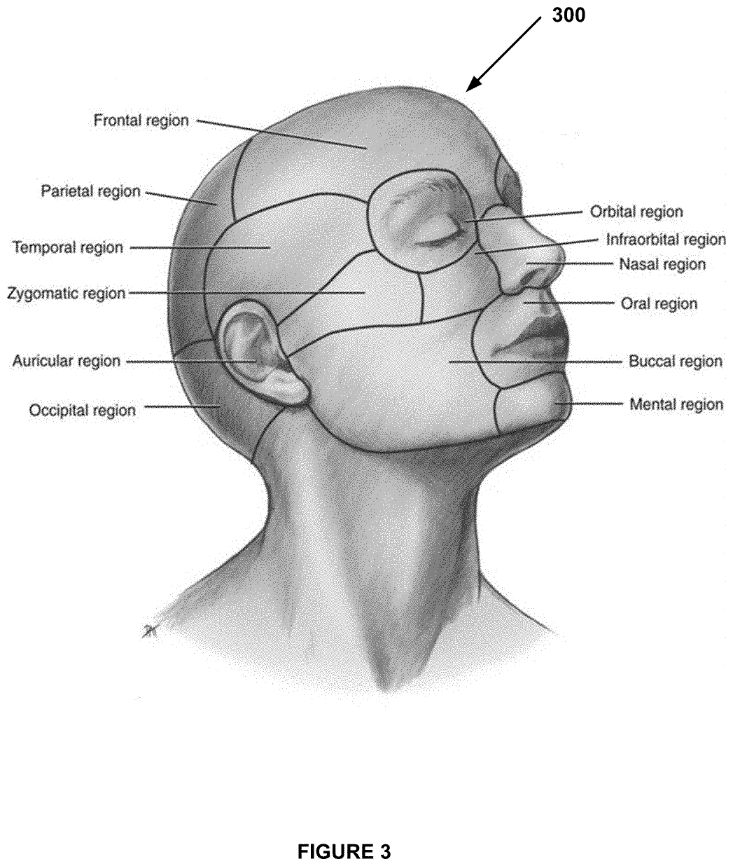

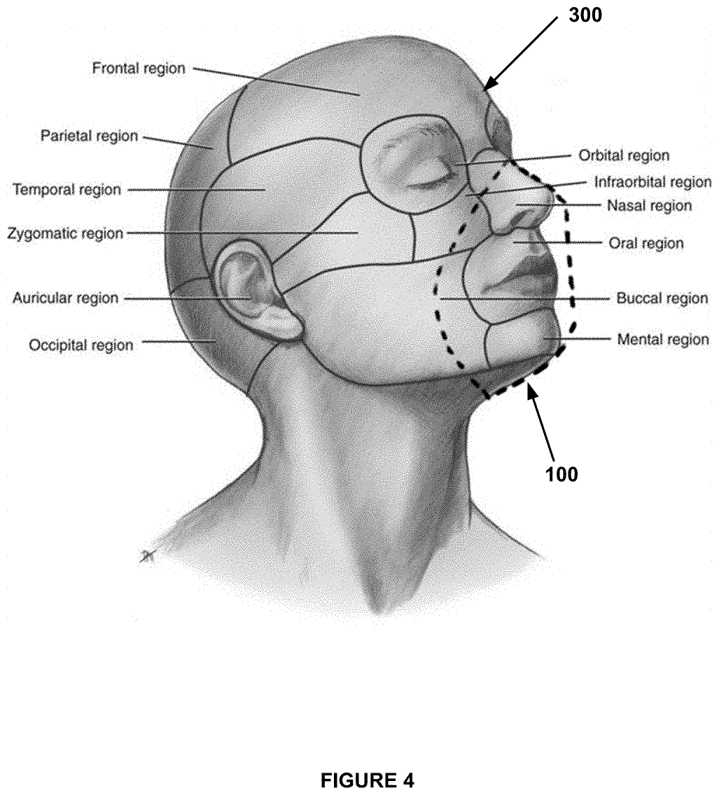

For a better understanding of the placement of the face mask body on the face, FIGS. 3 and 4 illustrate the regions of the face, so named for the major bone and muscle structures beneath the facial epidermis. FIG. 4 specifically illustrates the outline of the face mask body 100 as it would sit when properly placed by the wearer 300; the left lateral adhesive strip 200 is adapted to adhere to the facial epidermis on the left buccal and infraorbital regions of the face, and the right lateral adhesive strip 210 is adapted to adhere to the facial epidermis on the right buccal and infraorbital regions of the face.

The flexible nose bridge 300 of the face mask is located along the superior edge 110 of the face mask body 100 and allows the wearer 300 to “mold” the superior edge 110 of the face mask 100 to their personal facial dimensions. The nose bridge 300, when adapted to one's face by the wearer, lessens the amount of carbon dioxide escaping from the superior edge 110 of the face mask body 100 and, in wearers with eye glasses, reduces fogging on eyeglass lenses.

In one construction, the curved adhesive strips, such as those 200 and 210 pictured in FIG. 1 are designed to better fit the curvature of the right lateral 140 and left lateral 130 edges of the face mask body 100 and the buccal and infraorbital regions of the face. The strips 200 and 210 have a radius of curvation R1 that can match or be greater than the radius of curvature R2 of the right lateral 140 and left lateral 130 edges, respectively such that the ratio of R1 over R2 is greater than or equaled to 1.0 in absolute value. In another construction, the radius of curvature R1 can be smaller than the radius of curvature of the R2 of the right lateral 140 and left lateral 130 edges, respectively, such that the ratio of R1 over R2 is less than 1.0 in absolute value. In these arrangements, face mask body 100 stays sealed against the face skin during the bodily movement of the facial muscles. It is this way, inhaled air by the wearer has improved air filtration instead of receiving unfiltered air with potential droplets of COVID-19 or other air borne substances. Likewise, exhaled air is also treated by having a better seal. An embodiment with straight adhesive strips may be the used. In adult masks, the construction featuring curved adhesive strips retains the approximate 3.0 inches length and 0.5 inches width.

Aspects of the present disclosure provide a face mask body 100 with an adhesive mask system that adheres to the face to eliminate the need to loop the mask around the ears. Advantageously, mask 100 provides a loop free way of adhering a face mask to reduce the transmission of COVID-19. The masks may be provided in a variety of different colors, shapes and sizes to meet the needs of the individual wearing the mask. In operation, the wearer removes the backing of the self-adhesive strips 200, 210 along the right and left side of the loop free mask and applies the mask beginning at the top of the cheek bone (e.g., the infraorbital region) and smooths the mask body 100 downward toward the bottom jaw area (e.g., the buccal region).

When the wearer 300 is ready to take the mask off, the wearer grasps the top corner of the face mask body 100 between the thumb and index finger to peel the mask away from the face. While primary use is for individuals who want to safely social distance and reduce the risk of COVID-19 transmission, the masks of the present disclosure can also be used in the medical profession to protect medical professionals and patients during surgical procedures (for example). Additionally, masks of the present disclosure can be worn in a variety of different workplace settings to reduce the inhalation of toxins in the workplace as applicable.

The face masks that are currently on the market require loops to be worn around the ears, which can cause discomfort and irritation for some people, especially those with sensitive ears. The face mask 100 solve this issue by alleviating the need to use ear loops to hold the mask in place. This creates a more comfortable mask wearing experience for the wearer.

A KN95 or N95 face mask generally has multiple layers of nonwoven fabric, often made from polypropylene. The two outward protective layers of fabric, covering the inside and outside of the mask, are created using spun bonding. As known in the art, spun bonding uses nozzles blowing melted threads of a thermoplastic polymer to layer threads between 15-35 micrometers on a conveyor belt, which build up into cloth as the belt continues down the line. Fibers are then bonded using thermal, mechanical, or chemical techniques. The two outer layers of the respirator, between 20 and 50 g/m² in density, act as protection against the outside environment as well as a barrier to anything in the wearer's exhalations.

Between the spun bond layers there is a pre-filtration layer, which can be as dense as 250 g/m², and the filtration layer. The prefiltration layer is usually a needled nonwoven. The prefiltration layer is then provided through a hot calendaring process, in which plastic fibers are thermally bonded by running them through high pressure heated rolls. This makes the pre-filtration layer thicker and stiffer, so it can be molded to form the desired shape and stay in that shape as the mask is used.

The last layer is a high efficiency melt-blown electret (or polarized) nonwoven material, which determines the filtration efficiency. Melt blowing is a known process similar to spun bonding, in which multiple machine nozzles use air to spray threads of melted synthetic polymers onto a conveyor. However, these fibers are much smaller, as less than a micron wide. As the conveyor continues, the threads build up and bond by themselves as they cool, creating the fabric.

While illustrative apparatus as described herein embodying various aspects of the present disclosure are shown, it may be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or sub-combination with elements of the other embodiments. It may also be appreciated and understood that modifications may be made without departing from the true spirit and scope of the present disclosure. The description is thus to be regarded as illustrative instead of restrictive on the present disclosure.

What is claimed is:

1. A loop-free face mask body, comprising of:
a superior edge; an inferior edge; a right lateral edge; a left lateral edge;
a first curved adhesive strip being juxtaposed to the right lateral edge of a posterior display of the face mask body with respect to a midline; and
a second curved adhesive strip being juxtaposed to the left lateral edge of the posterior display of the face mask body with respect to the midline; wherein the first curved adhesive strip and the second curved adhesive strip are adapted to releasably engage an epidermis of a wearer, and the face mask body is free of ear loops for a wearer.

2. The face mask body according to claim 1, further comprising multiple layers of air filter material.

3. The face mask body according to claim 2, wherein the superior top edge further comprises a nose bridge juxtaposed thereto for molding around the nose of a wearer.

4. The face mask body according to claim 3, wherein the first curved adhesive strip and the second curved adhesive strip are adapted to adhere to a buccal region and infraorbital region on both sides of a face of a wearer.

5. The face mask body according to claim 4, wherein the first curved adhesive strip and the second curved adhesive strip further comprise a peeled film arranged to expose a medical-grade adhesive.

6. A loop-free face mask body, comprising of:
a superior edge; an inferior edge; a right lateral edge; a left lateral edge;
a right bucca-infraorbital skin adhesive strip being juxtaposed to the right lateral edge of a posterior display of the face mask body; and
a left bucca-infraorbital skin adhesive strip being juxtaposed to the left lateral edge of the posterior display of the face mask body.

7. The face mask body according to claim 6, further comprising multiple layers of air filter material, including a pre-filter.

8. The face mask body according to claim 7, wherein the superior top edge further comprises a nose bridge juxtaposed thereto for molding around the nose of a wearer.

9. The face mask body according to claim 8, wherein the right bucca-infraorbital skin adhesive strip and the left bucca-infraorbital skin adhesive strip are adapted to adhere to the buccal region and infraorbital region on a right side and left side, respectively of a face of a wearer.

10. The face mask body according to claim 9, wherein the right bucca-infraorbital skin adhesive strip and the left bucca-infraorbital skin adhesive strip are curved along the right lateral edge and the left lateral edge, respectively, of the face mask body.

11. The face mask body according to claim 10, wherein the right bucca-infraorbital skin adhesive strip and the left bucca-infraorbital skin adhesive strip further comprise a silicone adhesive.

12. The face mask body according to claim 10, wherein the face mask body is adapted to be worn over a nasal region, the infraorbital region, an oral region, a zygomatic region, the buccal region, and a mental region of a face of a wearer.
